(19) United States
(12) Patent Application Publication
(10) Pub. No.: US 2025/0296047 A1
(43) Pub. Date: Sep. 25, 2025

(54) CARBON DIOXIDE PROCESS APPARATUS, CARBON DIOXIDE PROCESS METHOD, AND MANUFACTURING METHOD OF CARBON COMPOUND

(71) Applicant: HONDA MOTOR CO., LTD., Tokyo (JP)

(72) Inventor: Hiroshi Oikawa, Wako-shi (JP)

(21) Appl. No.: 19/055,550

(22) Filed: Feb. 18, 2025

(30) Foreign Application Priority Data
Mar. 19, 2024 (JP) 2024-044153

(51) Int. Cl. B01D 53/96; B01D 53/14; B01D 53/62; B01D 53/78; C25B 1/04; C25B 3/03; C25B 3/26; C25B 9/23; C25B 15/08; H01M 8/0656; H01M 10/30; H01M 16/00

(52) U.S. Cl. CPC B01D 53/965; B01D 53/1425; B01D 53/1475; B01D 53/62; B01D 53/78; C25B 1/04; C25B 3/03; C25B 3/26; C25B 9/23; C25B 15/081; H01M 8/0656; H01M 10/30; H01M 16/006; B01D 2251/304; B01D 2251/306; B01D 2251/604; B01D 2257/504

(57) ABSTRACT

A carbon dioxide process apparatus includes: a recovery device that includes a carbon dioxide absorption portion which dissolves carbon dioxide in an electrolytic solution of a strong alkali and absorbs the carbon dioxide; an electrochemical reaction device to which the electrolytic solution in which the carbon dioxide is dissolved by the carbon dioxide absorption portion is supplied and which electrochemically reduces the carbon dioxide; an anion exchange type fuel cell that supplies electric energy to the electrochemical reaction device; a carbon dioxide concentration gas supply passage that supplies a carbon dioxide concentration gas generated by the fuel cell to the electrolytic solution which is discharged from the recovery device and before being supplied to the electrochemical reaction device; and a hydrogen supply passage that supplies hydrogen generated by the electrochemical reaction device to the fuel cell.

### CROSS-REFERENCE TO RELATED APPLICATION

Priority is claimed on Japanese Patent Application No. 2024-044153, filed on Mar. 19, 2024, the contents of which are incorporated herein by reference.

### BACKGROUND

### Field of the Invention

The present invention relates to a carbon dioxide process apparatus, a carbon dioxide process method, and a manufacturing method of a carbon compound.

### Background

In the related art, efforts to reduce the impact on or to relax climate change have been ongoing, and toward the realization of this purpose, research and development related to reducing carbon dioxide emissions has been conducted. For example, in order to reduce carbon dioxide emissions, a technique in which carbon dioxide in the atmosphere or exhaust gas is recovered and is electrochemically reduced, and valuables are obtained is known. Although this technique is a promising technique that can achieve carbon neutrality, an economic efficiency is the largest problem. In order to improve the economic efficiency, it is important to enhance the energy efficiency and reduce the loss of carbon dioxide in the recovery and the reduction of carbon dioxide. As a technique of recovering carbon dioxide, a technique is known in which carbon dioxide in a gas is physically or chemically adsorbed by a solid or liquid adsorbent, is then desorbed by the energy such as heat, and is utilized. Further, as a technique of electrochemically reducing carbon dioxide, a technique is known in which with respect to a cathode in which a catalyst layer is formed on a side of a gas diffusion layer that is in contact with an electrolytic solution by using a carbon dioxide reduction catalyst, a carbon dioxide gas is supplied from a side of the gas diffusion layer opposite to the catalyst layer and is electrochemically reduced (for example, refer to PCT International Publication No. WO2018/232515).

### SUMMARY

However, in the related art, with respect to the technique of recovering carbon dioxide and the technique of electrochemically reducing carbon dioxide, research and development has been separately conducted. Therefore, although the overall energy efficiency and the loss reduction effect of carbon dioxide when the respective techniques are combined can be determined in a multiplicative manner from the efficiency of each technique, there is room for further improvement. In this way, from the comprehensive viewpoint of combining the technique of recovering carbon dioxide and the technique of electrochemically reducing carbon dioxide, it is significant to enhance the energy efficiency and the loss reduction effect of carbon dioxide.

Further, it has been found that, in a process apparatus of carbon dioxide having a recovery device that recovers carbon dioxide, when the pH of an electrolytic solution that dissolves carbon dioxide is high, a hydrogen generation amount is increased at the time of the electrochemical reduction of carbon dioxide, and the decomposition efficiency of carbon dioxide is deteriorated. On the other hand, in the recovery device of carbon dioxide, the higher pH of the electrolytic solution is advantageous from the viewpoint of the absorption rate of the carbon dioxide. The fact that there is a gap in the optimum pH condition of the electrolytic solution between the electrolysis and the recovery of the carbon dioxide is a large problem in a carbon dioxide process apparatus.

As described above, in the conversion efficiency improvement of carbon dioxide, it is a problem to enhance both the recovery efficiency and the electrolysis efficiency of the carbon dioxide.

An aspect of the present invention aims at providing, in a carbon dioxide process apparatus that recovers carbon dioxide and electrochemically reduces the carbon dioxide, a technique capable of improving the absorption rate and the decomposition efficiency of the carbon dioxide compared to the related art. Further, the aspect of the present invention contributes to reduction of the impact on or relaxation of climate change.

A carbon dioxide process apparatus according to a first aspect of the present invention includes: a recovery device that includes a carbon dioxide absorption portion which dissolves carbon dioxide in an electrolytic solution of a strong alkali and absorbs the carbon dioxide; an electrochemical reaction device to which the electrolytic solution in which the carbon dioxide is dissolved by the carbon dioxide absorption portion is supplied and which electrochemically reduces the carbon dioxide; an anion exchange type fuel cell that supplies electric energy to the electrochemical reaction device; a carbon dioxide concentration gas supply passage that supplies a carbon dioxide concentration gas generated by the fuel cell to the electrolytic solution which is discharged from the recovery device and before being supplied to the electrochemical reaction device; and a hydrogen supply passage that supplies hydrogen generated by the electrochemical reaction device to the fuel cell.

According to the carbon dioxide process apparatus of the first aspect, the carbon dioxide concentration gas generated by the fuel cell can be supplied to the electrolytic solution before being electrolyzed via the carbon dioxide concentration gas supply passage. Thereby, it is possible to prevent the electrolysis of water and the generation of hydrogen in the electrochemical reaction device and to enhance the efficiency of the electrolysis reaction of the carbon dioxide. Additionally, according to the carbon dioxide process apparatus of the first aspect, electric energy can be generated by using the hydrogen generated in the electrochemical reaction device and be supplied to the electrochemical reaction device. Therefore, according to the carbon dioxide process apparatus of the first aspect, it is possible to enhance the efficiency of the electrolysis reaction of the carbon dioxide and to improve the energy efficiency.

A second aspect is the carbon dioxide process apparatus according to the first aspect, wherein the electrochemical reaction device may include: a cathode; an anode; an electrolyte film that is provided between the cathode and the anode; a cathode-side liquid flow path which is provided adjacent to the cathode and through which the electrolytic solution flows; an anode-side liquid flow path which is provided adjacent to the anode and through which the electrolytic solution flows; and a first liquid supply passage that supplies the electrolytic solution which has flowed through the cathode-side liquid flow path to the anode-side liquid flow path.

A third aspect is the carbon dioxide process apparatus according to the first or second aspect which may further include: an electric energy storage device that supplies electric energy to the electrochemical reaction device, wherein the electric energy storage device may include: a conversion portion that converts renewable energy into electric energy; and an electric energy storage portion that is constituted of a nickel hydrogen battery which stores the electric energy converted by the conversion portion, and the electrochemical reaction device may further include: a second liquid supply passage that supplies the electrolytic solution which has flowed through the anode-side liquid flow path to the nickel hydrogen battery.

A fourth aspect is the carbon dioxide process apparatus according to any one of the first to third aspects which may further include: a carbon increase reaction device that performs a carbon increase by performing multimerization of an ethylene generated by reducing the carbon dioxide by the electrochemical reaction device.

A fifth aspect of the present invention is a carbon dioxide process method that electrochemically reduces carbon dioxide, the carbon dioxide process method including: dissolving carbon dioxide in an electrolytic solution; reducing the carbon dioxide dissolved in the electrolytic solution; supplying hydrogen that is generated at a time of reduction of the carbon dioxide to an anion exchange type fuel cell and performing electricity generation; and supplying a carbon dioxide concentration gas that is generated at a time of the electricity generation to the electrolytic solution after dissolving the carbon dioxide and prior to the reduction of the carbon dioxide and decreasing pH of the electrolytic solution.

A carbon compound manufacturing method according to a sixth aspect of the present invention includes: reducing carbon dioxide and manufacturing a carbon compound by the carbon dioxide process method according to the fifth aspect.

According to the aspect of the present invention, in a carbon dioxide process apparatus that recovers carbon dioxide and electrochemically reduces the carbon dioxide, it is possible to improve the absorption rate and the decomposition efficiency of the carbon dioxide compared to the related art.

### BRIEF DESCRIPTION OF THE DRAWINGS

FIG. 1 is a block diagram showing a carbon dioxide process apparatus according to an embodiment of the present invention.

FIG. 2 is a schematic cross-sectional view showing an example of an electrolysis cell of an electrochemical reaction portion.

FIG. 3A is a view showing a nickel hydrogen battery of an electric energy storage portion at the time of discharging.

FIG. 3B is a view showing the nickel hydrogen battery of the electric energy storage portion at the time of charging.

### DESCRIPTION OF EMBODIMENTS

Hereinafter, embodiments of the present invention will be described in detail with reference to the drawings.

### [Carbon Dioxide Process Apparatus]

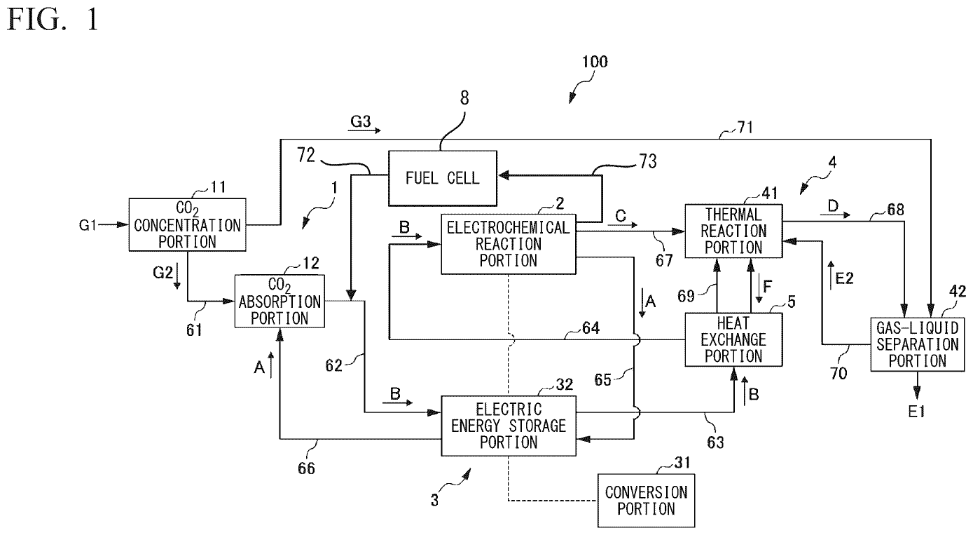

FIG. 1 is a block diagram showing a carbon dioxide process apparatus 100 according to an embodiment of the present invention.

As shown in FIG. 1, a carbon dioxide process apparatus 100 according to the present embodiment includes a recovery device 1, an electrochemical reaction portion 2 (electrochemical reaction device), an electric energy storage device 3, a carbon increase reaction device 4, a heat exchange portion 5, an anion exchange type fuel cell 8, a carbon dioxide concentration gas supply passage 72, and a hydrogen supply passage 73. The recovery device 1 includes a CO₂ concentration portion 11 and a CO₂ absorption portion 12 (carbon dioxide absorption portion). The electrochemical reaction portion 2 includes an electrolysis cell. The electric energy storage device 3 includes a conversion portion 31 and an electric energy storage portion 32. The carbon increase reaction device 4 includes a thermal reaction portion 41 and a gas-liquid separation portion 42.

In the carbon dioxide process apparatus 100, the CO₂ concentration portion 11 and the CO₂ absorption portion 12 are connected by a gas flow path 61. The CO₂ absorption portion 12 and the electric energy storage portion 32 are connected to each other by a liquid flow path 62 and a liquid flow path 66. The electric energy storage portion 32 and the heat exchange portion 5 are connected to each other by a liquid flow path 63. The heat exchange portion 5 and the electrochemical reaction portion 2 are connected to each other by a liquid flow path 64. The electrochemical reaction portion 2 and the electric energy storage portion 32 are connected to each other by a second liquid supply passage 65 which is a liquid flow path. The electrochemical reaction portion 2 and the thermal reaction portion 41 are connected to each other by a gas flow path 67. The thermal reaction portion 41 and the gas-liquid separation portion 42 are connected to each other by a gas flow path 68 and a gas flow path 70. A circulation flow path 69 of a heat medium is provided between the thermal reaction portion 41 and the heat exchange portion 5. The CO₂ concentration portion 11 and the gas-liquid separation portion 42 are connected to each other by a gas flow path 71. The fuel cell 8 and a liquid flow path (that is, one or more of the liquid flow path 62, the liquid flow path 63, and the liquid flow path 64) that supplies an electrolytic solution B from CO₂ absorption portion 12 to the electrochemical reaction portion 2 are connected to each other by the carbon dioxide concentration gas supply passage 72. The fuel cell 8 and the electrochemical reaction portion 2 are connected to each other by the hydrogen supply passage 73.

Each flow path described above is not particularly limited, and known piping or the like can be appropriately used. A gas supply means such as a compressor, a valve, a measurement device such as a flowmeter, and the like can be appropriately provided on the gas flow paths 61, 67, 68, 70, and 71, the carbon dioxide concentration gas supply passage 72, and the hydrogen supply passage 73.

Further, a liquid supply means such as a pump, a valve, a measurement device such as a flowmeter, and the like can be appropriately provided on the liquid flow paths 62 to 66.

### (Recovery Device)

The recovery device 1 recovers carbon dioxide. A gas G1 that includes carbon dioxide such as air or exhaust gas is supplied to the CO₂ concentration portion 11. The CO₂ concentration portion 11 concentrates the carbon dioxide in the gas G1. As the CO₂ concentration portion 11, a known concentration device can be employed as long as the device can concentrate carbon dioxide. As the CO₂ concentration portion 11, for example, a membrane separation device that utilizes a difference in a permeation rate with respect to a membrane or an adsorption separation device that utilizes chemical or physical adsorption or desorption can be used. From the viewpoint of excellent separation performance, adsorption that utilizes, in particular, temperature swing adsorption of chemisorption is preferable.

A concentration gas G2 in which the carbon dioxide is concentrated by the CO₂ concentration portion 11 is supplied to the CO₂ absorption portion 12 through the gas flow path 61. Further, a separation gas G3 that is separated from the concentration gas G2 is supplied to the gas-liquid separation portion 42 through the gas flow path 71.

In the CO₂ absorption portion 12, a carbon dioxide gas in the concentration gas G2 supplied from the CO₂ concentration portion 11 comes into contact with an electrolytic solution A, and the carbon dioxide is dissolved in the electrolytic solution A and is absorbed. The method of causing the carbon dioxide gas to come into contact with the electrolytic solution A is not particularly limited, and examples of the method can include a method of performing bubbling by blowing the concentration gas G2 into the electrolytic solution A.

In the CO₂ absorption portion 12, an electrolytic solution A constituted of a strong alkaline aqueous solution is used as an absorption liquid that absorbs carbon dioxide. In the carbon dioxide, since the oxygen atom strongly attracts the electron, the carbon atom has a positive electric charge (δ+). Therefore, in the strong alkaline aqueous solution in which a large amount of hydroxide ions are present, with respect to the carbon dioxide, a dissolution reaction tends to proceed from a hydrated state through HCO₃⁻ to CO₃²⁻, and the state becomes an equilibrium state in which the abundance ratio of CO₃²⁻ is high. Therefore, the carbon dioxide is more easily dissolved in the strong alkaline aqueous solution than other gases such as nitrogen, hydrogen, and oxygen, and the carbon dioxide in the concentration gas G2 is selectively absorbed by the electrolytic solution A in the CO₂ absorption portion 12. In this way, by using the electrolytic solution A in the CO₂ absorption portion 12, concentration of the carbon dioxide can be promoted. Therefore, it is not necessary to concentrate the carbon dioxide to a high concentration in the CO₂ concentration portion 11, and it is possible to reduce the energy required for the concentration in the CO₂ concentration portion 11.

An electrolytic solution B in which the carbon dioxide is absorbed in the CO₂ absorption portion 12 is sent to the electrochemical reaction portion 2 through the liquid flow path 62, the electric energy storage portion 32, the liquid flow path 63, the heat exchange portion 5, and the liquid flow path 64. Further, the electrolytic solution A that flows out from the electrochemical reaction portion 2 is sent to the CO₂ absorption portion 12 through the second liquid supply passage 65, the electric energy storage portion 32, and the liquid flow path 66. In this way, in the carbon dioxide process apparatus 100, the electrolytic solution is circulated among the CO₂ absorption portion 12, the electric energy storage portion 32, and the electrochemical reaction portion 2.

Examples of the strong alkaline aqueous solution used for the electrolytic solution A include a potassium hydroxide aqueous solution and a sodium hydroxide aqueous solution. In particular, the potassium hydroxide aqueous solution is preferably used from the viewpoint that the solubility of carbon dioxide in the CO₂ absorption portion 12 is excellent, and the reduction of carbon dioxide in the electrochemical reaction portion 2 is promoted.

### (Electrochemical Reaction Portion)

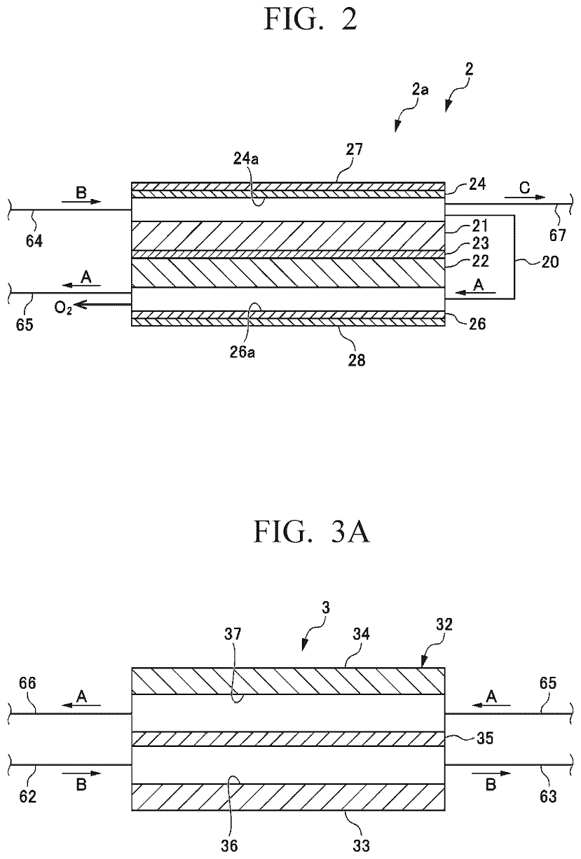

FIG. 2 is a schematic cross-sectional view showing an example of an electrolysis cell 2a of the electrochemical reaction portion 2. The electrochemical reaction portion 2 electrochemically reduces carbon dioxide by the electrolysis cell 2a. As shown in FIG. 2, the electrolysis cell 2a of the electrochemical reaction portion 2 includes a cathode 21, an anode 22, an anion exchange membrane 23 (electrolyte film), a cathode-side liquid flow path structure 24 that forms a cathode-side liquid flow path 24a, an anode-side liquid flow path structure 26 that forms an anode-side liquid flow path 26a, an electric power supply body 27, and an electric power supply body 28. Although one electrolysis cell 2a is shown in FIG. 2, the electrochemical reaction portion 2 can preferably include an electrolysis cell stack formed by stacking a plurality of electrolysis cells 2a.

In the electrolysis cell 2a of the electrochemical reaction portion 2, the electric power supply body 27, the cathode-side liquid flow path structure 24, the cathode 21, the anion exchange membrane 23, the anode 22, the anode-side liquid flow path structure 26, and the electric power supply body 28 are stacked in this order. Further, the cathode-side liquid flow path 24a is formed between the cathode 21 and the cathode-side liquid flow path structure 24. The anode-side liquid flow path 26a is formed between the anode 22 and the anode-side liquid flow path structure 26. The cathode-side liquid flow path 24a and the anode-side liquid flow path 26a are provided at positions that face each other across the cathode 21, the anion exchange membrane 23, and the anode 22. A plurality of cathode-side liquid flow paths 24a and a plurality of anode-side liquid flow paths 26a can be preferably provided. The shape of the cathode-side liquid flow path 24a and the anode-side liquid flow path 26a may be a straight line or a zigzag shape.

The electric power supply body 27 and the electric power supply body 28 are electrically connected to the electric energy storage portion 32 of the electric energy storage device 3. Further, both the cathode-side liquid flow path structure 24 and the anode-side liquid flow path structure 26 are electric conductors and can apply a voltage between the cathode 21 and the anode 22 by electric power supplied from the electric energy storage portion 32.

The cathode 21 is an electrode that reduces carbon dioxide to generate a carbon compound, and also reduces water to generate hydrogen. Examples of the cathode 21 can include an electrode that includes a gas diffusion layer and a cathode catalyst layer formed on the cathode-side liquid flow path 24a side of the gas diffusion layer.

The cathode catalyst layer may be arranged such that part of the cathode catalyst layer enters the inside of the gas diffusion layer. Further, a porous layer that is denser than the gas diffusion layer may be arranged between the gas diffusion layer and the cathode catalyst layer.

A known catalyst that promotes reduction of carbon dioxide can be used as a cathode catalyst that forms the cathode catalyst layer. Specific examples of the cathode catalyst can include metals such as gold, silver, copper, platinum, palladium, nickel, cobalt, iron, manganese, titanium, cadmium, zinc, indium, gallium, lead, and tin, alloys thereof, intermetallic compounds, and metal complexes such as ruthenium complexes and rhenium complexes. Among them, from the viewpoint of promoting reduction of carbon dioxide, copper and silver are preferable, and copper is more preferably used. As the cathode catalyst, one type may be used alone, or two or more types may be used in combination. As the cathode catalyst, a supported catalyst in which metallic particles are supported by a carbon material (carbon particles, carbon nanotubes, graphene, or the like) may be used.

The gas diffusion layer of the cathode 21 is not particularly limited, and examples of the gas diffusion layer can include a carbon paper and a carbon cloth. The manufacturing method of the cathode 21 is not particularly limited, and examples of the manufacturing method can include a method in which a slurry of a liquid composition including the cathode catalyst is applied on a surface of the gas diffusion layer on the cathode-side liquid flow path 24a side and is dried.

The anode 22 is an electrode that oxidizes a hydroxide ion and generates oxygen. Examples of the anode 22 can include an electrode that includes a gas diffusion layer and an anode catalyst layer formed on the anode-side liquid flow path 26a side of the gas diffusion layer. The anode catalyst layer may be arranged such that part of the anode catalyst layer enters the inside of the gas diffusion layer. Further, a porous layer that is denser than the gas diffusion layer may be arranged between the gas diffusion layer and the anode catalyst layer.

An anode catalyst that forms the anode catalyst layer is not particularly limited, and a known anode catalyst can be used. Specific examples can include metals such as platinum, palladium, and nickel, alloys thereof, intermetallic compounds, metal oxides such as manganese oxides, iridium oxides, nickel oxides, cobalt oxides, iron oxides, tin oxides, indium oxides, ruthenium oxides, lithium oxides, and lanthanum oxides, and metal complexes such as ruthenium complexes and rhenium complexes. As the anode catalyst, one type may be used alone, or two or more types may be used in combination.

Examples of the gas diffusion layer of the anode 22 can include a carbon paper and a carbon cloth. Further, as the gas diffusion layer, porous bodies such as mesh materials, punched materials, madreporites, and metallic fiber sintered bodies may be used. Examples of the material of the porous bodies can include metals such as titanium, nickel, and iron, and alloys thereof (for example, SUS).

Examples of the material of the cathode-side liquid flow path structure 24 and the anode-side liquid flow path structure 26 can include metals such as titan and SUS, and carbon.

Examples of the material of the electric power supply body 27 and the electric power supply body 28 can include metals such as copper, gold, titanium, and SUS, and carbon. A structure obtained by applying a plating process such as gold plating on a surface of a copper base material may be used as the electric power supply body 27 and the electric power supply body 28.

The electrolysis cell 2a of the electrochemical reaction portion 2 is a flow cell in which the electrolytic solution B supplied from the CO₂ absorption portion 12 and sent via the electric energy storage portion 32 and the heat exchange portion 5 flows into the cathode-side liquid flow path 24a. Then, by applying a voltage to the cathode 21 and the anode 22, the dissolved carbon dioxide in the electrolytic solution B that flows through the cathode-side liquid flow path 24a is electrochemically reduced by the cathode 21, and a carbon compound and hydrogen are generated. The electrolytic solution B at an entrance of the cathode-side liquid flow path 24a is in a weak alkali state in which the abundance ratio of CO₃²⁻ is high since the carbon dioxide is dissolved. On the other hand, a dissolved carbon dioxide amount, that is, a CO₃²⁻ amount in the electrolytic solution is decreased as the electrolytic solution flows through the cathode-side liquid flow path 24a, and the reduction proceeds, and thereby, the electrolytic solution becomes an electrolytic solution A in a strong alkali state at an exit of the cathode-side liquid flow path 24a.

Examples of the carbon compound generated by reducing carbon dioxide by the cathode 21 can include carbon monoxide, ethylene, and the like. For example, the following reaction proceeds, and thereby, carbon monoxide and ethylene are generated as gaseous products. In the cathode 21, hydrogen is also generated by the following reaction. The generated carbon compound in a gas form and hydrogen flow out from the exit of the cathode-side liquid flow path 24a. The carbon compound and the hydrogen can be separated, for example, by a means such as membrane separation. The hydrogen is supplied to the anion exchange type fuel cell 8 described later through the hydrogen supply passage 73.

CO₂+H₂O→CO+2OH⁻

2CO+8H₂O→C₂H₄+8OH⁻+2H₂O

2H₂O→H₂+2OH⁻

The hydroxide ion generated by the cathode 21 passes through the anion exchange membrane 23, moves to the anode 22, and is oxidized by the following reaction, and oxygen is generated. The generated oxygen passes through the gas diffusion layer of the anode 22, flows into the anode-side liquid flow path 26a, and flows out from the exit of the anode-side liquid flow path 26a.

4OH⁻→O₂+2H₂O

In this way, in the carbon dioxide process apparatus 100, the electrolytic solution used by the electrochemical reaction portion 2 is shared as an absorption solution of the CO₂ absorption portion 12, and the carbon dioxide is supplied to the electrochemical reaction portion 2 while being dissolved in the electrolytic solution B and is electrochemically reduced. Thereby, for example, as compared with the case where carbon dioxide is adsorbed by an adsorbent, is desorbed by heating, and is reduced, the energy required for desorption of carbon dioxide is reduced, and it is possible to enhance the energy efficiency.

Here, in the reduction reaction of the carbon dioxide that proceeds at the cathode 21, a by-product is also generated in addition to the carbon compound such as ethylene as a target. Specifically, by-products such as methanol, ethanol, acetic acid, and formic acid are generated, the by-products are dissolved in the electrolytic solution, and it is difficult to separate the by-products. Therefore, the loss of carbon dioxide occurs, and reduction of the loss is desired.

Specifically, at the cathode 21, the following reduction reaction of carbon dioxide proceeds, and thereby, methanol, ethanol, acetic acid, and formic acid are generated. Therefore, the electrolytic solution A that has flowed through the cathode-side liquid flow path 24a includes the by-products such as the methanol, ethanol, acetic acid, and formic acid.

2CO₃²⁻+12H₂O+12e⁻→2CH₃OH+16OH⁻2CO₃²⁻+11H₂O+12e⁻→C₂H₅OH+16OH⁻2CO₃²⁻+8H₂O+8e⁻→CH₃COOH+12OH⁻2CO₃²⁻+6H₂O+4e⁻→2HCOOH+8OH⁻

On the other hand, the electrolysis cell 2a of the electrochemical reaction portion 2 according to the present embodiment includes a first liquid supply passage 20 that supplies the electrolytic solution A that has flowed through the cathode-side liquid flow path 24a to the anode-side liquid flow path 26a. The first liquid supply passage 20 supplies the electrolytic solution A that flows out from the exit of the cathode-side liquid flow path 24a and includes the by-products such as the methanol, ethanol, acetic acid, and formic acid into the anode-side liquid flow path 26a from the entrance of the anode-side liquid flow path 26a. Thereby, the by-products such as the methanol, ethanol, acetic acid, and formic acid are oxidized by an oxidation reaction that proceeds at the anode 22 and are recovered in a form of carbon dioxide (CO₃²⁻) and electron (e⁻).

Specifically, at the anode 22, the oxidation reaction as described below of the by-products such as the methanol, ethanol, acetic acid, and formic acid proceeds, and thereby, the by-products are converted into the form of carbon dioxide (CO₃²⁻) and electron (e⁻). The electrolytic solution A which has flowed through the anode-side liquid flow path 26a and in which the by-products are converted into the form of carbon dioxide (CO₃²⁻) and electron (e⁻) is supplied by the second liquid supply passage 65 to the nickel hydrogen battery that constitutes the electric energy storage portion 32 described later. In this way, in the electrolysis cell 2a of the electrochemical reaction portion 2 according to the present embodiment, it is possible to recover and recycle carbon dioxide, and it is possible to reduce the loss of carbon dioxide and improve the energy efficiency.

2CH₃OH+16OH⁻→2CO₃²⁻+12H₂O+12e⁻C₂H₅OH+16OH⁻→2CO₃²⁻+11H₂O+12e⁻CH₃COOH+12OH⁻→2CO₃²⁻+8H₂O+8e⁻2HCOOH+8OH⁻→2CO₃²⁻+6H₂O+4e⁻

### (Fuel Cell)

With reference back to FIG. 1, the fuel cell 8 is a device that produces electric energy from hydrogen and oxygen. Here, the fuel cell 8 is an anion exchange type fuel cell. The anion exchange type fuel cell is also referred to as a hydroxide exchange membrane fuel cell (HEMFC). The anion exchange type fuel cell that includes a shorted membrane which conducts both anions and electrons functions as an electrochemically driven CO₂ separator (EDCS) that removes CO₂ from supply air, and most of CO₂ that is included in an intake air on the cathode side can be removed and concentrated to exhaust air on the anode side (for example, Lin Shi, et.al, “A shorted membrane electrochemical cell powered by hydrogen to remove CO₂ from the air feed of hydroxide exchange membrane fuel cells”, Nature Energy volume 7, pages 238-247, 2022).

The fuel cell 8 and the electrochemical reaction portion 2 are connected to each other via the hydrogen supply passage 73. The hydrogen generated at the electrochemical reaction portion 2 is supplied to the fuel cell 8. The fuel cell 8 utilizes the hydrogen and generates electric energy. The electric energy is supplied to the electrochemical reaction portion 2.

Hydrogen is generated at the cathode 21 of the electrochemical reaction portion 2 by an electrolysis reaction of water. The electrolysis reaction of water consumes electric energy and decreases the electrolysis efficiency of carbon dioxide.

However, the carbon dioxide process apparatus 100 according to the present embodiment recovers hydrogen, converts the hydrogen into electric energy by using the fuel cell 8, and supplies the electric energy to the electrochemical reaction portion 2. According to the fuel cell 8, part of the electric energy consumed by the electrolysis of water can be compensated.

Further, the fuel cell 8 and the liquid flow path that supplies the electrolytic solution B from the CO₂ absorption portion 12 to the electrochemical reaction portion 2 are connected to each other by the carbon dioxide concentration gas supply passage 72.

The carbon dioxide concentration gas supply passage 72 supplies the carbon dioxide concentration gas generated at the fuel cell 8 to the electrolytic solution B that is discharged from the recovery device 1 and before being supplied to the electrochemical reaction portion 2.

Here, in the carbon dioxide process apparatus 100 shown in FIG. 1, the liquid flow path 62 that connects the CO₂ absorption portion 12 and the electric energy storage portion 32 to each other, the liquid flow path 63 that connects the electric energy storage portion 32 and the heat exchange portion 5 to each other, and the liquid flow path 64 that connects the heat exchange portion 5 and the electrochemical reaction portion 2 to each other are provided between the CO₂ absorption portion 12 and the electrochemical reaction portion 2. In the carbon dioxide process apparatus 100 shown in FIG. 1, the carbon dioxide concentration gas supply passage 72 connects the fuel cell 8 and the liquid flow path 62 to each other. However, the carbon dioxide concentration gas supply passage 72 may connect the fuel cell 8 and the liquid flow path 63 to each other or may connect the fuel cell 8 and the liquid flow path 64 to each other.

The carbon dioxide concentration gas supply passage 72 supplies the carbon dioxide concentration gas to the electrolytic solution B and decreases pH of the electrolytic solution B. By decreasing pH of the electrolytic solution B, it is possible to reduce a hydrogen generation amount in the electrochemical reaction portion 2 and further improve the decomposition efficiency of carbon dioxide.

The pH of the electrolytic solution A supplied from the electrochemical reaction portion 2 to the CO₂ absorption portion 12 can be preferably about 14 or slightly less than 14. In the carbon dioxide process apparatus 100 of the related art, when pH of the electrolytic solution A is increased to about 14 or slightly less than 14, the carbon dioxide decomposition efficiency in the electrochemical reaction portion 2 is decreased. However, according to the study of the present inventor, by supplying the carbon dioxide concentration gas to the electrolytic solution B discharged from the CO₂ absorption portion 12, pH of the electrolytic solution B can be decreased to about 12 or slightly less than 12 which is a suitable value for the electrochemical reaction portion 2.

### (Electric Energy Storage Device)

With reference back to FIG. 1, the electric energy storage device 3 is a device that supplies electric power to the electrochemical reaction portion 2. In the conversion portion 31, renewable energy is converted into electric energy. The conversion portion 31 is not particularly limited, and examples of the conversion portion 31 can include a wind turbine generator, a photovoltaic generator, a geothermal generator, and the like. The electric energy storage device 3 may include a single conversion portion 31 or may include a plurality of conversion portions 31.

The electric energy storage portion 32 is electrically connected to the conversion portion 31. The electric energy converted by the conversion portion 31 is stored in the electric energy storage portion 32. By storing the converted electric energy in the electric energy storage portion 32, electric power can be stably supplied to the electrochemical reaction portion 2 even in a period of time when the conversion portion 31 does not generate electric power. Further, when renewable energy is utilized, the voltage variation generally tends to be large; however, by once storing the converted electric energy in the electric energy storage portion 32, electric power can be supplied at a stable voltage to the electrochemical reaction portion 2.

The electric energy storage portion 32 of the present embodiment is constituted of a nickel hydrogen battery. However, the electric energy storage portion 32 may be one capable of charging and discharging and may be constituted of, for example, a lithium-ion secondary battery or the like.

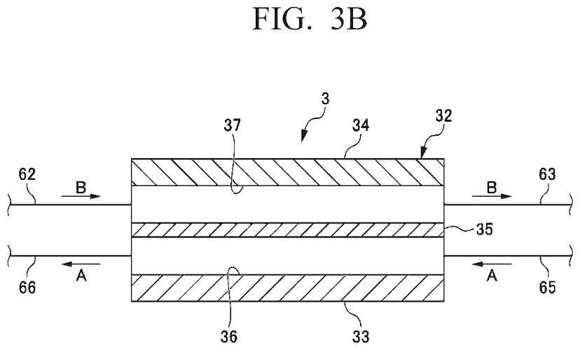

Here, FIG. 3A is a view showing a nickel hydrogen battery of the electric energy storage portion 32 at the time of discharging. FIG. 3B is a view showing the nickel hydrogen battery of the electric energy storage portion 32 at the time of charging. As shown in FIG. 3A and FIG. 3B, the electric energy storage portion 32 is a nickel hydrogen battery including a positive electrode 33, a negative electrode 34, a separator 35 that is provided between the positive electrode 33 and the negative electrode 34, a positive electrode-side flow path 36 that is formed between the positive electrode 33 and the separator 35, and a negative electrode-side flow path 37 that is formed between the negative electrode 34 and the separator 35. The positive electrode-side flow path 36 and the negative electrode-side flow path 37 can be formed, for example, by using a liquid flow path structure similar to those of the cathode-side liquid flow path 24a and the anode-side liquid flow path 26a of the electrochemical reaction portion 2.

Examples of the positive electrode 33 can include one in which a positive electrode active material is applied to a positive electrode-side flow path 36 side of a positive electrode electricity collection body. The positive electrode electricity collection body is not particularly limited, and examples of the positive electrode electricity collection body can include a nickel foil and a nickel-coated metal foil. The positive electrode active material is not particularly limited, and examples of the positive electrode active material can include nickel hydroxide and nickel oxyhydroxide.

Examples of the negative electrode 34 can include one in which a negative electrode active material is applied to a negative electrode-side flow path 37 side of a negative electrode electricity collection body. The negative electrode electricity collection body is not particularly limited, and examples of the negative electrode electricity collection body can include a nickel mesh. The negative electrode active material is not particularly limited, and examples of the negative electrode active material can include a known hydrogen storage alloy.

The separator 35 is not particularly limited, and examples of the separator 35 can include an ion exchange membrane.

The nickel hydrogen battery of the electric energy storage portion 32 is a flow cell in which the electrolytic solution flows through each of the positive electrode-side flow path 36 on the positive electrode 33 side of the separator 35 and the negative electrode-side flow path 37 on the negative electrode 34 side of the separator 35. In the carbon dioxide process apparatus 100 of the present embodiment, the electrolytic solution B supplied from the CO₂ absorption portion 12 through the liquid flow path 62 and the electrolytic solution A supplied from the electrochemical reaction portion 2 through the second liquid supply passage 65 are supplied to and flow through the positive electrode-side flow path 36 and the negative electrode-side flow path 37, respectively.

Further, each connection of the liquid flow path 62 and the liquid flow path 63 to the electric energy storage portion 32 can be switched between a state of connection to the positive electrode-side flow path 36 and a state of connection to the negative electrode-side flow path 37, for example, by a switching valve or the like. Similarly, each connection of the second liquid supply passage 65 and the liquid flow path 66 to the electric energy storage portion 32 can be switched between a state of connection to the positive electrode-side flow path 36 and a state of connection to the negative electrode-side flow path 37, for example, by a switching valve or the like.

At the time of discharging of the nickel hydrogen battery, a hydroxide ion is generated from a water molecule at the positive electrode 33, and the hydroxide ion that has moved to the negative electrode 34 receives a hydrogen ion from the hydrogen storage alloy to generate a water molecule. Therefore, from the viewpoint of the discharging efficiency, it is advantageous that the electrolytic solution that flows through the positive electrode-side flow path 36 is in a weak alkali state, and it is advantageous that the electrolytic solution that flows through the negative electrode-side flow path 37 is in a strong alkali state. Therefore, at the time of discharging, as shown in FIG. 3A, it can be preferable that the liquid flow path 62 and the liquid flow path 63 are connected to the positive electrode-side flow path 36, the second liquid supply passage 65 and the liquid flow path 66 are connected to the negative electrode-side flow path 37, the electrolytic solution B in a weak alkali state that is supplied from the CO₂ absorption portion 12 flows through the positive electrode-side flow path 36, and the electrolytic solution A in a strong alkali state that is supplied from the electrochemical reaction portion 2 flows through the negative electrode-side flow path 37. That is, at the time of discharging, the electrolytic solution can be preferably circulated in the order of the CO₂ absorption portion 12, the positive electrode-side flow path 36 of the electric energy storage portion 32, the electrochemical reaction portion 2, the negative electrode-side flow path 37 of the electric energy storage portion 32, and the CO₂ absorption portion 12.

Further, at the time of charging of the nickel hydrogen battery, a water molecule is generated from a hydroxide ion at the positive electrode 33, the water molecule is decomposed into a hydrogen atom and a hydroxide ion at the negative electrode 34, and the hydrogen atom is occluded in the hydrogen storage alloy. Therefore, from the viewpoint of the charging efficiency, it is advantageous that the electrolytic solution that flows through the positive electrode-side flow path 36 is in a strong alkali state, and it is advantageous that the electrolytic solution that flows through the negative electrode-side flow path 37 is in a weak alkali state. Therefore, at the time of charging, as shown in FIG. 3B, it can be preferable that the liquid flow path 62 and the liquid flow path 63 are connected to the negative electrode-side flow path 37, the second liquid supply passage 65 and the liquid flow path 66 are connected to the positive electrode-side flow path 36, the electrolytic solution B in a weak alkali state that is supplied from the CO₂ absorption portion 12 flows through the negative electrode-side flow path 37, and the electrolytic solution A in a strong alkali state that is supplied from the electrochemical reaction portion 2 flows through the positive electrode-side flow path 36. That is, at the time of charging, the electrolytic solution can be preferably circulated in the order of the CO₂ absorption portion 12, the negative electrode-side flow path 37 of the electric energy storage portion 32, the electrochemical reaction portion 2, the positive electrode-side flow path 36 of the electric energy storage portion 32, and the CO₂ absorption portion 12.

In general, when a secondary battery is incorporated into a device, the overall energy efficiency tends to be decreased by the amount of a charging-discharging efficiency. However, in the present embodiment, as described above, by utilizing a pH gradient of the electrolytic solution A and the electrolytic solution B before and after the electrochemical reaction portion 2, and suitably switching the electrolytic solution that flows through the positive electrode-side flow path 36 and the negative electrode-side flow path 37 of the electric energy storage portion 32, it is possible to improve a charging-discharging efficiency of the amount of “concentration overpotential” of an electrode reaction represented by a Nernst equation.

With reference back to FIG. 1, the carbon increase reaction device 4 is a device that performs a carbon increase by performing multimerization of an ethylene generated by reducing carbon dioxide by the electrochemical reaction device 2. An ethylene gas C generated by the reduction at the cathode 21 of the electrochemical reaction portion 2 is sent to the thermal reaction portion 41 through the gas flow path 67. In the thermal reaction portion 41, a multimerization reaction of ethylene is performed in the presence of an olefin multimerization catalyst. Thereby, for example, it is possible to manufacture an olefin having an increased carbon such as 1-butene, 1-hexene, or 1-octene.

The olefin multimerization catalyst is not particularly limited, and a known catalyst used for a multimerization reaction can be used. Examples of the olefin multimerization catalyst can include a solid acid catalyst that uses silica alumina or zeolite as a carrier, and a transition metal complex compound.

In the carbon increase reaction device 4 of the present embodiment, a generation gas D after the multimerization reaction that flows out from the thermal reaction portion 41 is sent to the gas-liquid separation portion 42 through the gas flow path 68. An olefin having a carbon number of 6 or more is a liquid at ordinary temperatures. Therefore, for example, when the olefin having a carbon number of 6 or more is a target carbon compound, by setting the temperature of the gas-liquid separation portion 42 to about 30° C., it is possible to easily perform gas-liquid separation to an olefin (olefin liquid E1) having a carbon number of 6 or more and an olefin (olefin gas E2) having a carbon number of less than 6. Further, by increasing the temperature of the gas-liquid separation portion 42, the carbon-number of the obtained olefin liquid E1 can be increased.

When the gas G1 supplied to the CO₂ concentration portion 11 of the recovery device 1 is atmospheric air, the separation gas G3 sent from the CO₂ concentration portion 11 through the gas flow path 71 may be utilized for the cooling of the generation gas D in the gas-liquid separation portion 42. For example, by using a gas-liquid separation portion 42 including a cooling tube, causing the separation gas G3 to pass through the inside of the cooling tube, causing the generation gas D to pass through the outside of the cooling tube, and condensing the generation gas D by a surface of the cooling tube, the olefin liquid E1 is obtained. Further, since the olefin gas E2 separated by the gas-liquid separation portion 42 includes an unreacted component such as ethylene and an olefin having a smaller carbon number than that of a target olefin, the olefin gas E2 can return to the thermal reaction portion 41 through the gas flow path 70 and be reused for the multimerization reaction.

The multimerization reaction of ethylene in the thermal reaction portion 41 is an exothermic reaction in which the enthalpy of a supply material is higher than the enthalpy of a generation material, and a reaction enthalpy is negative. In the carbon dioxide process apparatus 100, a heat medium F is heated by utilizing a reaction heat generated at the thermal reaction portion 41 of the carbon increase reaction device 4, the heat medium F is circulated to the heat exchange portion 5 through the circulation flow path 69, and heat is exchanged between the heat medium F and the electrolytic solution B in the heat exchange portion 5. Thereby, the electrolytic solution B supplied to the electrochemical reaction portion 2 is heated. In the electrolytic solution B that uses a strong alkaline aqueous solution, if the temperature is increased, the dissolved carbon dioxide is not easily separated as a gas, and a reaction rate of the oxidation-reduction in the electrochemical reaction portion 2 is improved by the increase of the temperature of the electrolytic solution B.

The carbon increase reaction device 4 may further include a reaction portion that performs a hydrogenation reaction of an olefin obtained by the multimerization of ethylene by utilizing the hydrogen generated by the electrochemical reaction portion 2, or a reaction portion that performs an isomerization reaction of an olefin or a paraffin.

### [Carbon Dioxide Process Method]

A carbon dioxide process method according to an embodiment of the present invention is performed, for example, by using the carbon dioxide process apparatus 100 described above. Specifically, the carbon dioxide process method of the present embodiment can preferably include: a step (a) of dissolving carbon dioxide in an electrolytic solution; a step (b) of reducing the carbon dioxide dissolved in the electrolytic solution; a step (c) of supplying hydrogen that is generated at the time of reduction of the carbon dioxide to a fuel cell and performing electricity generation; and a step (d) of supplying a carbon dioxide concentration gas that is generated at the time of the electricity generation to the electrolytic solution after dissolving the carbon dioxide and prior to the reduction of the carbon dioxide and decreasing pH of the electrolytic solution. The carbon dioxide process method of the present embodiment can be utilized for a carbon compound manufacturing method. That is, by using the carbon dioxide process method of the present embodiment, it is possible to manufacture a carbon compound in which carbon dioxide is reduced, or a carbon compound obtained by using the carbon compound in which carbon dioxide is reduced as a raw material.

Further, the carbon dioxide process method of the present embodiment is characterized in that, in the electrochemical reduction of carbon dioxide as in the step (b) described above, the electrolytic solution A that has flowed through the cathode-side liquid flow path 24a which is provided adjacent to the cathode 21 is supplied to the anode-side liquid flow path 26a which is provided adjacent to the anode 22. Thereby, by-products such as methanol, ethanol, acetic acid, and formic acid that are generated by a reduction reaction of the cathode 21 can be oxidized by an oxidation reaction that proceeds at the anode 22 and be recovered and recycled in a form of carbon dioxide (CO₃²⁻) and electron (e⁻), and it is possible to reduce the loss of carbon dioxide and improve the energy efficiency.

Further, as in the case where the carbon dioxide process apparatus including the carbon increase reaction device 4 is used as in the carbon dioxide process apparatus 100 described above, the carbon dioxide process method of the present embodiment can preferably further include a step (e) of performing multimerization of an ethylene generated by reducing the dissolved carbon dioxide in addition to the step (a) to step (d).

The present disclosure is not limited to the embodiments described above, and modifications and improvements within a scope in which the object of the present disclosure can be achieved are included in the present disclosure.

Further, for example, a branch liquid flow path that is connected to the CO₂ absorption portion 12 via a switching valve such as a three-way valve may be provided on the first liquid supply passage 20 of the embodiment described above. Thereby, by switching the switching valve, it is possible to supply the electrolytic solution A directly to the CO₂ absorption portion 12 via the branch liquid flow path.

Further, the carbon dioxide process apparatus 100 of the embodiment described above has a configuration including the recovery device 1, the electric energy storage device 3, the carbon increase reaction device 4, and the heat exchange portion 5; however, the embodiment is not limited thereto. The carbon dioxide process apparatus 100 may have a configuration that does not include all or part of the recovery device 1, the electric energy storage device 3, the carbon increase reaction device 4, and the heat exchange portion 5.

What is claimed is:

1. A carbon dioxide process apparatus comprising:
a recovery device that comprises a carbon dioxide absorption portion which dissolves carbon dioxide in an electrolytic solution of a strong alkali and absorbs the carbon dioxide;
an electrochemical reaction device to which the electrolytic solution in which the carbon dioxide is dissolved by the carbon dioxide absorption portion is supplied and which electrochemically reduces the carbon dioxide;
an anion exchange type fuel cell that supplies electric energy to the electrochemical reaction device;
a carbon dioxide concentration gas supply passage that supplies a carbon dioxide concentration gas generated by the fuel cell to the electrolytic solution which is discharged from the recovery device and before being supplied to the electrochemical reaction device; and
a hydrogen supply passage that supplies hydrogen generated by the electrochemical reaction device to the fuel cell.

2. The carbon dioxide process apparatus according to claim 1,
wherein the electrochemical reaction device comprises:
a cathode;
an anode;
an electrolyte film that is provided between the cathode and the anode;
a cathode-side liquid flow path which is provided adjacent to the cathode and through which the electrolytic solution flows;
an anode-side liquid flow path which is provided adjacent to the anode and through which the electrolytic solution flows; and
a first liquid supply passage that supplies the electrolytic solution which has flowed through the cathode-side liquid flow path to the anode-side liquid flow path.

3. The carbon dioxide process apparatus according to claim 1, further comprising:
an electric energy storage device that supplies electric energy to the electrochemical reaction device,
wherein the electric energy storage device comprises:
a conversion portion that converts renewable energy into electric energy; and
an electric energy storage portion that is constituted of a nickel hydrogen battery which stores the electric energy converted by the conversion portion, and
the electrochemical reaction device further comprises:
a second liquid supply passage that supplies the electrolytic solution which has flowed through the anode-side liquid flow path to the nickel hydrogen battery.

4. The carbon dioxide process apparatus according to claim 1, further comprising:
a carbon increase reaction device that performs a carbon increase by performing multimerization of an ethylene generated by reducing the carbon dioxide by the electrochemical reaction device.

5. The carbon dioxide process apparatus according to claim 2, further comprising:
an electric energy storage device that supplies electric energy to the electrochemical reaction device,
wherein the electric energy storage device comprises:
a conversion portion that converts renewable energy into electric energy; and
an electric energy storage portion that is constituted of a nickel hydrogen battery which stores the electric energy converted by the conversion portion, and
the electrochemical reaction device further comprises:
a second liquid supply passage that supplies the electrolytic solution which has flowed through the anode-side liquid flow path to the nickel hydrogen battery.

6. The carbon dioxide process apparatus according to claim 2, further comprising:
a carbon increase reaction device that performs a carbon increase by performing multimerization of an ethylene generated by reducing the carbon dioxide by the electrochemical reaction device.

7. A carbon dioxide process method that electrochemically reduces carbon dioxide, the carbon dioxide process method comprising:
dissolving carbon dioxide in an electrolytic solution;
reducing the carbon dioxide dissolved in the electrolytic solution;
supplying hydrogen that is generated at a time of reduction of the carbon dioxide to an anion exchange type fuel cell and performing electricity generation; and
supplying a carbon dioxide concentration gas that is generated at a time of the electricity generation to the electrolytic solution after dissolving the carbon dioxide and prior to the reduction of the carbon dioxide and decreasing pH of the electrolytic solution.

8. A carbon compound manufacturing method comprising:
reducing carbon dioxide and manufacturing a carbon compound by the carbon dioxide process method according to claim 7.
